(19) United States
(12) Patent Application Publication
(10) Pub. No.: US 2026/0057432 A1
(43) Pub. Date: Feb. 26, 2026

(54) HEIRARCY-BASED SEARCH

(71) Applicants: Horacio Duhart, Plano, TX (US); Arturo Duhart, Plano, TX (US)

(72) Inventors: Horacio Duhart, Plano, TX (US); Arturo Duhart, Plano, TX (US)

(21) Appl. No.: 19/378,334

(22) Filed: Nov. 4, 2025

Related U.S. Application Data
(63) Continuation of application No. 18/414,460, filed on Jan. 17, 2024, now abandoned.
(63) Continuation-in-part of application No. 17/738,000, filed on May 5, 2022, now abandoned.
(60) Provisional application No. 63/184,203, filed on May 5, 2021.

(51) Int. Cl. G06Q 30/0601

(52) U.S. Cl. CPC G06Q 30/0631; G06Q 30/0633

(57) ABSTRACT

The present invention provides a hierarchy-based search system and method primarily used to shop for products (including services as well). The system includes either multiple rows or multiple columns arranged as user-selectable tiles (including buttons) that together incorporate hierarchies of product abstraction which include, from a broadest meta (large) product categories, to one or more granular (specific) product categories. Then, as a user searches for a product or service, that search and the results of the search are augmented by user-selectable tiles that further limit/filter the displayed search results such that only results consistent with the category selection are displayed to the user. Accordingly, a natural sequence of purchasing choice selection decisions is presented to the user so that they can more naturally narrow shopping choices and make faster, better purchasing decisions.

### CLAIM OF PRIORITY, IDENTIFICATION OF RELATED APPLICATIONS

This Non-Provisional Patent Application is a Continuation of pending U.S. patent application Ser. No. 18/414,460 filed 17 Jan. 2024, which is a Continuation in Part of and claims priority to co-pending U.S. patent application Ser. No. 17/738,000 entitled HIERARCHY-BASED SELECTION to common inventor Horacio Duhart, which claims priority from U.S. Provisional Patent Application No. 63/184,203 filed on 5 May 2021 entitled Hierarchy-Based Selection also to common inventor Horacio Duhart.

### TECHNICAL FIELD

The present invention generally relates to data processing and presentation techniques for e-commerce, and more specifically relates to interactive online shopping tools and interactive online shopping methods.

### PROBLEM STATEMENT AND HISTORY

### Interpretation Considerations

This section describes technical field in detail and discusses problems encountered in the technical field. Therefore, statements in the section are not to be construed as prior art.

### Discussion of History of the Problem

In addition to convenience, speed and competitive pricing, we can now add global pandemics to the list of reasons why consumers are choosing to make more of their purchases online. Yet in 2020—despite the pandemic—less than 20% of consumer purchases in the United States and other places were made online. Accordingly, online sales are trending to continue to become more common and have plenty of room to grow.

When internet shopping was beginning in the early 2000s, platforms such as eBay® presented customers with a confusing variety of shopping options. Fast forward to today and platform-based online shopping “stores” on eBay® and Amazon® provide sellers the ability to reach their customers in ways that add value (and price) to a transaction.

However, when consumers shop online, they are faced with difficult to navigate interfaces that make product (including service) categories difficult to navigate and filter. Specifically check-boxes and drop-down selection tools confuse consumers and often consume 25% or more of a website or App's visual footprint (also called ‘visual real estate’ and/or ‘visible screen display area’).

Accordingly, what is needed is an online shopping tool provides consumers a better shopping experience, and guides the consumer to visually see the few selections on the screen that match what he/she is really looking for while consuming a smaller visual footprint. The present invention provides such a solution.

### Topically Related Publications

Software technology for online shopping systems is a busy field dense with new technologies and patent application filings, such as:
WO2016000044, titled as online shopping system and method of purchase of products by customers, the method comprising: in respect of a plurality of items available from each of a plurality of retailers, obtaining the price of each item for purchase from each retailer; receiving an indicator of a region from a customer (region indicator); receiving a list of items for purchase from the customer; determining the cost of each of the items in the received list for each of the retailers based on the received region indicator; and determining a shopping list for each retailer based on the determined costs. But the application does not disclose about brands and prior art system does not provide filtering by brand, moreover, the prior art is not related to solar power industry products.
U.S. Pat. No. 20,140,351090 titled as graphical user interface for presentation of items and is related to methods and apparatuses for presenting a user interface for visual search results are described herein. The methods include indexing a plurality of metadata values of each of a plurality of items and generating a plurality of item categories based on the plurality of metadata values, and determining a primary item category and a subordinate item category from the plurality of categories. But the patent application does not claim features of the present invention with respect to brand selection.
U.S. Pat. No. 7,996,282 titled as method and system for selecting and displaying items related to methods and systems for causing the display of items for the review and selection thereof by a potential purchaser has a plurality of search tools whereby a customer can select certain search criteria for displaying items corresponding to the search criteria for review and selection thereof and comparison there between. The prior art application fails to disclose brand row search.

### SUMMARY

The invention provides a method of exploring and selecting retail products (including herein services) via a selectively stacked sequence of displayed consumer choices (or “offerings”), including meta (large) product categories, granular (specific) product categories, and product type categories. The display of results changes dynamically based on, at least in part, the user's section(s), preferably without requiring an additional “selection” step (such as a search), where the user must press a ‘return’ key, “click” a search button, or otherwise indicate that a search is to be made and/or that the display is to be updated.

One embodiment associated with user-selection hierarchies of product abstraction which include, from broadest to most narrow: meta (large) product categories, granular (specific) product categories, and product types category, product sub-type category 1, product sub-type category 2, etc.

In one embodiment, the method displays choices related to products, presented as:
1. A first row or column displaying a series of tiles or buttons (“first row tiles”, where each first-row tile comprises an image and/or a word, where each tile is of a generalized product meta-category.
2. A second row or column displaying a series of tiles or buttons (“second row tiles”), where each second-row tile comprises an image and/or a word, where each tile further narrows one or more of the meta categories. If the user has selected a meta category, then the second-row tiles that are displayed relate only to the previously selected first row tile, and are defined as a granular product category.
3. A third row/column displaying a series of tiles or buttons (“third row tiles”), where each third-row tile comprises an image and/or a word, where each tile further narrows one or more of the granular product category into a sub-type category 1, such as a brand name. Of course, depending on the context of display, a brand may be any of a meta category down to a sub-type category. If the user has selected a third-row tile, then the brands displayed relate only to the previously selected second-row tile. For example, if a user has selected a second-row tile of “solar panels” then the third-row tiles all display brands of solar panels, such as SHARP®, JA Solar®, or Jinko Solar®.
4. A fourth row/column displaying a series of tiles or buttons (“fourth row tiles”), where each fourth-row tile comprises an image and/or a word, where each fourth-row tile further narrows one or more of the granular product category(ies) into a sub-type 2 category, such as a solar panel type of the brand name selected. Of course, depending on the context of display, a brand may be any of a meta category down to a sub-type category. If the user has selected the fourth-row tile, then the brands displayed relate only to the previously selected third-row tile. For example, if a user has selected a second-row tile of “solar panels” and SHARP as the only brand from the third-row tile, then the fourth-row tiles all display types of solar panels available from SHARP, such as poly, mono, bifacial, and the like.
5. As a user makes each tile selection, the products shown to the user reflect the products available at the selected level of abstraction.

Accordingly, initially, when no selections have been made, a bottom portion of a sales page may display promoted items or items presented/sorted based on retailer or user preferences.

Then, as a user selects a meta category (first-row tile), the items displayed at the bottom of the page change dynamically to reflect the smaller set of items that now meet that choice criteria. Further, the choices available to a user in the second-row tile are now limited to choices that are consistent with that selection. Similarly, if a user selects a more narrow category, such as a granular category, before selecting a meta category, the method automatically incorporates the relevant meta-categories as being also selected and automatically displays these now-active meta category(ies) to the user as if it/they were selected. Likewise, as the user selects each more narrow sub-category, the items displayed at the bottom of the page change dynamically to reflect the smaller set/sub-set(s) of items that now meet that choice criteria.

Of course, the present is simply a Summary, and not a complete description of the invention.

### BRIEF DESCRIPTION OF THE DRAWINGS

Various aspects of the invention and its embodiment are better understood by referring to the following detailed description. To understand the invention, the detailed description should be read in conjunction with the drawings, in which:

FIG. 1 illustrates overview of an online retail product/service search system.

FIG. 2 is a flow chart illustrating an interactive online shopping algorithm (aka “online hierarchical search algorithm”).

FIG. 3 illustrates a flow chart describing an online hierarchical search algorithm with respect to display and comparative product analysis for products belonging to same brand in connection with FIG. 2.

FIG. 4 illustrates procedural acts of a cart selection algorithm on a retail database in connection with FIG. 2.

FIG. 5 illustrates an example handheld electronic device presenting product search by implementing the online hierarchical search algorithm.

FIG. 6 is an example screenshot of the online hierarchical search for an inverter.

FIG. 7 is an example flow chart illustrating the interactive online shopping algorithm.

FIG. 8 is an example screenshot of the online hierarchical search for a solar panel.

FIG. 9 is another example screenshot of the online hierarchical search for the invertor.

### DESCRIPTION OF AN EXEMPLARY PREFERRED EMBODIMENT INTERPRETATION CONSIDERATIONS

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

An electronic device includes any physical electronic human-machine interface such as a laptop, a notebook, a desktop computer, a vehicle to everything (V2X) device, a smartphone, a tablet, an internet of things (IoT) device, a television with communication facility, an immersive device, a virtual reality device, or any other computing device including similar hardened and/or field-specific devices, for example. Further, electronic devices include touch screens including smart television screens, Electric Car touch screens, convenient store or mall information kiosk touch screens, for example.

A processor may be a general-purpose processor, such as a central processing unit (CPU), an application processor (AP), a graphics-only processing unit such as a graphics processing unit (GPU), a visual processing unit (VPU), or an artificial intelligence (AI)-dedicated processor such as a neural processing unit (NPU), for example.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### DESCRIPTION OF THE DRAWINGS, A PREFERRED EMBODIMENT

### Introduction

The present invention generally relates to online and touch screen shopping software and has application across a variety of different retail and wholesale shopping environments, such as electric cars, smart televisions, smart phones applications, and clothing, for example. More broadly, the invention is a hierarchical search tool that has application across structured data generally.

In one embodiment of the present invention, what is provided are a row or column (or both, collectively herein “row” to encompass the broadest meaning of the word) of naturally sequenced tiles (herein tiles includes buttons and icons) that assist users with making a selection during a purchasing process.

The present invention provides an effective platform for a user to select products (herein “products” includes services to encompass the broadest meaning of the word), where the user of an electronic device is empowered to make selections for a product category and then narrow down that selection so that the user is not overwhelmed with choices of displayed products ‘matching’ a nominal search—especially the reduction or elimination of the display of products irrelevant to the user.

Selection in this sense is independent of the hardware platform in use. Exemplary hardware platforms include hand-held devices, such as smart phones, pad-type computers, laptops, kiosk, smart televisions, desktops, or car display monitor, for example. Selections may be indicated verbally, by touch via a touch-screen display, with gestures including hand and eye gestures, for example.

In other words, the present invention provides a shopping tool that can be used online which provides consumers a better shopping experience by guiding the consumer to make additional purchases—ideally from that same seller. More broadly, the tool is an approach to select products by having users select categories of items, and then smaller sub-categories of those items.

### Description of the Drawings Figures

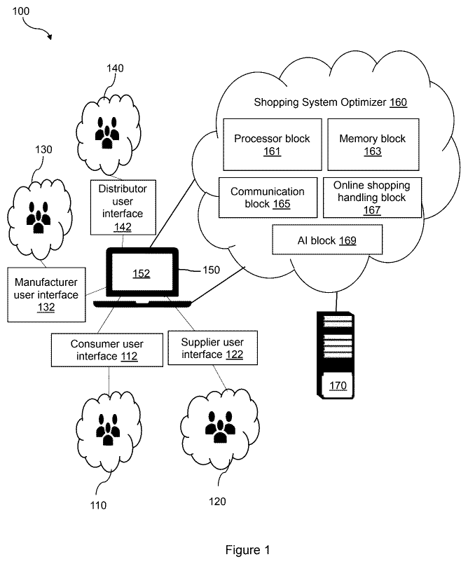

FIG. 1 illustrates an overview of the invention embodied as an online retail product/service search system (the “online retail search system” or the “hierarchy-based search system”) 100. The online retail search system 100 is accessed by consumer-users 110 through a consumer user interface 112, supplier-users 120 through a supplier user interface 122, manufacturer-users 130 through a manufacturer user interface 132, and distributor-users 140 through a distributor user interface 142. The online retail search system 100 itself is communicatively coupled to an electronic device (aka “user device”) 150 having a display screen 152.

The online retail search system 100 further comprises a shopping system optimizer 160 that includes a processor block 161, a memory block 163, a communication block 165, an online shopping handling block 167, and an Artificial Intelligence (AI) block 169. Although the shopping system optimizer 160 is shown in a cloud, it is appreciated by those of skill in the art upon reading this application that the shopping system optimizer 160 may operate in cloud computing, a local server 170, a remote server, or on a user device, for example. Additionally, the local server 170 may be selected to be (and includes within its meaning) an edge server, for example.

The processor block 161 represents the functionality and processing required to perform the processer block functions described below. The memory block 163 preferably includes a non-volatile memory and a volatile memory and stores the information/data relevant that fulfils the methods described herein. The communication block 165 manages the data flow (“communicates”) with various electronic devices including the electronic device 150, the shopping system optimizer 160 and the server 170, and in one embodiment comprises a plurality of APIs (Application Programming Interfaces).

The online shopping handling block 167 provides a way of exploring and selecting retail products (including herein services) via a selectively stacked sequence of displayed consumer choices (or “offerings”), including meta (large) product categories, granular (specific) product categories, and product type categories. The display of results changes dynamically based on, at least in part, the user's section(s), preferably without requiring an additional “selection” step (such as a search), where the user must press a ‘return’ key, “click” a search button, or otherwise indicate that a search is to be made and/or that the display is to be updated.

The online shopping handling block 167 provides user-selection hierarchies of product abstraction which include, from broadest to most narrow: meta (large) product categories, granular (specific) product categories, and product types category, product sub-type category 1, product sub-type category 2, etc. What defines a meta product category depends on the context of the search, and on the website in particular. For example, when shopping on a site such as Amazon with millions of available products, a meta product category may include categories such as “linens” or “automotive” or “hardware” or “clothing” or other common large retail categories. By contrast, if shopping on a website that sells a residential alternative energy product, then a meta product category may include categories such as “wind power” or “power storage” or “solar power” and the like. Similarly, if shopping on a website that sells residential solar power, then a meta-category may include “solar panels” or “batteries” or “installation tools” or “maintenance”. Accordingly, the more specific the shopping website, the more granular the meta category. The consequence of this is that the definition of what defines a category, from meta category down to a sub-type category 2 while hierarchically consistent within a specific embodiment, are relative across embodiments and their careful selection on the part of the software architect and user-experience specialist assists consumers in having a good shopping experience.

Based on an input provided by at least one user, the online shopping handling block 167 presents choices related to products (i.e., product choices) as a first row or column (or both, collectively herein “row” to encompass the broadest meaning of the word) on the display screen 152, where the first row or column displays a series of tiles or buttons (“first row tiles”), where each first-row tile comprises an image and/or a word (“first content”), where each first-row tile is of a generalized product meta-category.

Further, the online shopping handling block 167 presents a second row or column (or both, collectively herein “row” to encompass the broadest meaning of the word) displaying a series of tiles or buttons (“second row tiles”), where each second-row tile comprises an image and/or a word (or both, collectively herein “content” to encompass the broadest meaning of the word) (“second content”), where each second-row tile further narrows one or more of the meta categories. If the at least one user has selected a meta category, then the second-row tiles that are displayed relate only to the previously selected first row tile, and are defined as a granular product category.

The online shopping handling block 167 further presents/displays a third row or column (or both, collectively herein “row” to encompass the broadest meaning of the word) displaying a series of tiles or buttons (“third row tiles”), where each third-row tile comprises an image and/or a word (“third content), where each tile further narrows one or more of the granular product category(ies) into a first sub-type category, such as a brand name. Of course, depending on the context of display, a brand may be any of a meta category down to a sub-type category. If the at least one user has selected a third-row tile, then the brands displayed relate only to the previously selected second-row tile. For example, if a user has selected a second-row tile of “solar panels” then the third-row tiles all display brands of solar panels, such as SHARP®, JA Solar®, or Jinko Solar®.

The online shopping handling block 167 further presents a fourth row or column (or both, collectively herein “row” to encompass the broadest meaning of the word) displaying a series of tiles or buttons (“fourth row tiles”), where each fourth-row tile comprises an image and/or a word (“fourth content”), where each fourth-row tile further narrows the one or more of the granular product category(ies) into a second sub-type category, such as a solar panel type of the brand name selected. Of course, depending on the context of display, a brand may be any of a meta category down to a sub-type category. If the at least one user has selected a fourth-row tile, then the brands displayed relate only to the previously selected third-row tile. For example, if a user has selected a second-row tile of “solar panels” and SHARP as the only brand from the third-row tile, then the fourth-row tiles all display types of solar panels available from SHARP, such as poly, mono, bifacial, and the like.

In a nutshell, as the at least one user makes each tile selection, the products shown to the at least one user reflect the products available at the selected level of abstraction. That is, initially, when no selections have been made, a bottom portion of a sales page may display promoted items or items presented/sorted based on retailer or user preferences. Then, as the at least one user selects a meta category (first-row tile), the items displayed at the bottom of the page change dynamically to reflect the smaller set of items that now meet that choice criteria. Further, the choices available to a user in the second-row tile are now limited to choices that are consistent with that selection. Similarly, if a user selects a more narrow (i.e., narrower) category, such as a granular category, before selecting a meta category, the online shopping handling block 167 automatically incorporates the relevant meta-categories as being also selected and automatically displays these now-active meta category(ies) to the at least one user as if it/they were selected. Likewise, as the user selects each more narrow sub-category, the items displayed at the bottom of the page change dynamically to reflect the smaller set/sub-set(s) of items that now meet that choice criteria.

In an embodiment, the AI block 169 implements a machine learning method called deep learning. The machine learning method enables the platform to automatically learn and improve from experience, over a period of time, without being explicitly programmed. The deep learning method uses a neural network capable of learning in an unsupervised manner from data that is unstructured or unlabeled. Deep learning is a method of machine learning that employs multiple layers of neural networks that enable the platform of the present invention to teach itself through inference and pattern recognition, rather than development of procedural code or explicitly coded software algorithms (however, machine learning is augmented and enhanced with software algorithms). The neural networks are modeled according to the neuronal structure of a mammal's cerebral cortex, where neurons are represented as nodes and synapses are represented as uniquely weighted paths or “tolled roads” between the nodes. The nodes are then organized into layers to comprise a network. Additionally, the neural networks are organized in a layered fashion that includes an input layer, intermediate or hidden layers, and an output layer.

The neural networks enhance their learning capability by varying the uniquely weighted paths based on received input. The successive layers within the neural network incorporate the learning capability by modifying their weighted coefficients based on their received input patterns. From this foundation, one can see that the training of the neural networks is very similar to how we teach children to recognize an object. The neural network is repetitively trained from a base data set, where results from the output layer (or, simply “output”) are successively compared to the correct classification.

Alternatively, any machine learning paradigm instead of neural networks can be used in the training and learning process.

A function associated with the AI block 169 may be performed by utilizing the information stored in the memory block 163 and by utilizing the information processed by the processor block 161.

Although FIG. 1 shows various components of the online retail search system 100 but it is to be understood that other embodiments are not limited thereon. The online retail search system 100 may include less or more number of components. Further, the labels or names of the components are used only for illustrative purpose and do not limit the scope of the present invention. One or more components can be combined together to perform same or substantially similar function in the online retail search system 100.

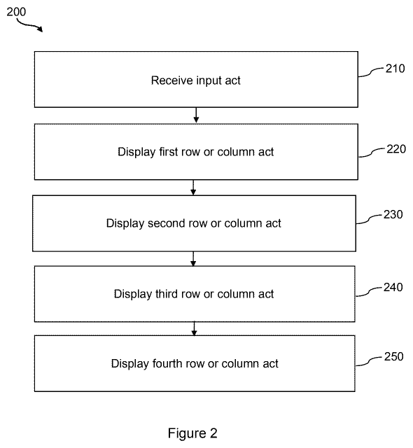

FIG. 2 is a flow chart illustrating an interactive online shopping algorithm 200 (aka “online hierarchical search algorithm 200”).

In a receive input act 210, the shopping system optimizer 160 receives the at least one input to present choices related to products as the first row or column on the display screen 152 in a display first row or column act 220, where the first row or column displays the series of tiles or buttons (“first row tiles”), where each first-row tile comprises the image and/or the word, where each first-row tile is of the generalized product meta-category.

Next, in a display second row or column act 230, the shopping system optimizer 160 presents the second row or column displaying the series of tiles or buttons (“second row tiles”), where each second-row tile comprises the image and/or the word, where each second-row tile further narrows one or more of the meta categories. That is, if the at least one user has selected a meta category, then the second-row tiles that are displayed relate only to the previously selected first row tile in the display second row or column act 230, and are defined as a granular product category.

Moving to a display third row or column act 240, the shopping system optimizer 160 further narrows down the outcome of the second row or column. In the display third row or column act 240, the shopping system optimizer 160 presents the third row or column displaying the series of tiles or buttons (“third row tiles”), where each third-row tile comprises the image and/or the word, where each tile further narrows one or more of the granular product category(ies) into the first sub-type category, such as a brand name as explained above. If the at least one user has selected the third-row tile, then the brands displayed relate only to the previously selected second-row tile.

Lastly, in a display fourth row or column act 250, the shopping system optimizer 160 presents the fourth row or column displaying the series of tiles or buttons (“fourth row tiles”), where each fourth-row tile comprises the image and/or the word, where each fourth-row tile further narrows the one or more of the granular product category(ies) into the second sub-type category, such as a solar panel type of the brand name selected. Of course, depending on the context of display, a brand may be any of a meta category down to a sub-type category. In other words, in the display fourth row or column act 250, if the at least one user has selected a fourth-row tile, then the brands displayed relate only to the previously selected third-row tile.

Based on the outcome of the above acts, the shopping system optimizer 160 may perform at least one action. The at least one action corresponds to end product search, a purchase order, a payment action, an adding to a cart action or combination thereof, for example.

Although, the online hierarchical search algorithm 200 is explained in view of the consumer 110, however, the online hierarchical search algorithm 200 is not limited to the consumer 110 only and is also applicable to the other users as explained in conjunction with FIG. 1.

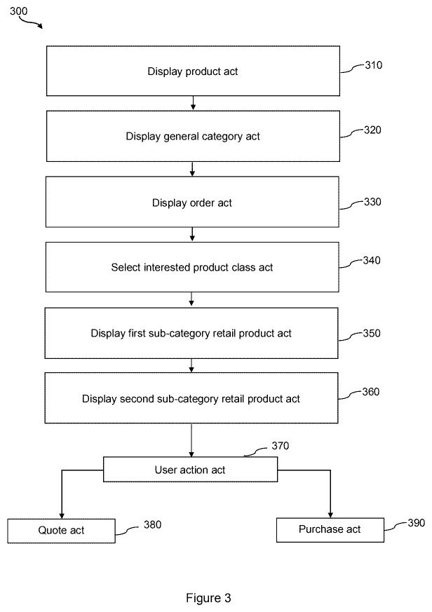

FIG. 3 illustrates a flow chart describing an online hierarchical search algorithm 300 with respect to display and comparative product analysis for products belonging to same brand in connection with FIG. 2.

In a display product act 310, the electronic device 150 displays images/text products from the memory block (aka “retail product database/memory block”) 163. The display of products is arranged in series of rows or columns and optionally. In various embodiments, the displayed information can be sequentially placed (in multiple windows) from left to right or from right to left, and from top to bottom or from bottom to top.

In a display general category act 320, the electronic device 150 displays the images/text details of products that belong to a generalized category. In a display order act 330, the products displayed are pre-arranged based on a seller criteria. In a select interested product class act 340, the at least one user 110 (for example, consumer 110) of the electronic device 150 selects a desired product class. In a display first sub-category retail product act 350, in response to the user selection, the electronic device 150 presents a new second row/column belonging to the class selected. Again, the user selection, in a display second sub-category retail product act 360, presents a new third row/column belonging to the class selected. In a user action act 370, the electronic device 150 presents a product selected by the user. With simultaneous reference to act 380 and act 390, the at least one user 110 of the electronic device 150 may save the selection as a Quote in a quote act 380 or directly to a cart for purchase in a purchase act 390.

Although, the online hierarchical search algorithm 300 is explained in view of the consumer 110, however, the online hierarchical search algorithm 300 is not limited to the consumer only and is also applicable to the other users as explained in FIG. 1.

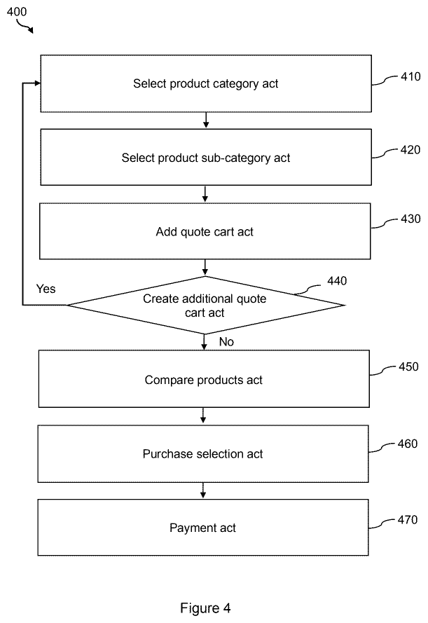

FIG. 4 illustrates procedural acts of a cart selection algorithm 400 on a retail database in connection with FIG. 2. The retail database may be located in the memory block 163, or in the online shopping handling block 167 or in the server 170.

In a select product category act 410, the at least one user 110 (for example “consumer”) of the electronic device 150 selects an image/text corresponding to a category of product; for example, image/text related to solar energy sector. In a select product sub-category act 420, the at least one user 110 of the electronic device 150 selects a sub-category of the product. Next, in an add quote cart act 430, the at least one user 110 of the electronic device 150 selects the product to add to a Quote cart. Next, in a create additional quote cart act 440, the at least one user 110 is provided with an option to create additional quote cart. If the at least one user 110 opts to create additional quote cart, the cart selection algorithm 400 proceeds to “Yes” path and the act 410 to act 430 are repeated until the at least one user 110 has filled the Quote cart with the products that are desired for purchase. Else, the cart selection algorithm 400 proceeds to “No” path.

Next, in compare products act 450, the electronic device 150 displays the quotes for comparison. Further, in a purchase selection act 460, the at least one user 110 of the electronic device 150 may assign points or weight to various criteria for making the purchase selection. Lastly, in a payment act 470, a selected quote is converted into a shopping cart for checkout and payment.

Although, the cart selection algorithm 400 is explained in view of the consumer 110, however, the cart selection algorithm 400 is not limited to the consumer only and is also applicable to the other users as explained in FIG. 1.

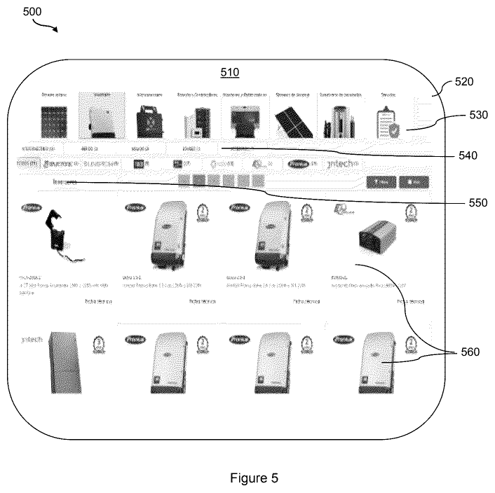

FIG. 5 illustrates a handheld electronic device 500 presenting product search by implementing the online hierarchical search algorithm 200. The handheld electronic device 500 has a hardware display screen 510 which, when on, presents a display 520 (window/web page) having display elements thereon, including images that represent brands, product types, solar components, power storage (such as batteries), installations tools, and the like.

More particularly, in FIG. 5 is seen selected functionality of the online shopping handling block 167 as employed in the online hierarchical search algorithm 200. The display 520 initially has an appearance that is similar to other consumer search tools. Here, a product category tool bar row 530 has elements shown as a series of images and words. Specifically, one element shows the words “Services” and has an image of a note pad with a check mark representing a completed task. Additionally, a row of product or service brands 540 is shown based on a user selection of an element in the product category toolbar row 530.

User feedback display tab 550 informs the user of the selection they made from the product category toolbar row 530 and/or the row of product or service brands 540. Common selection criteria that may be shown to the user via the user feedback display tab 550 include brands, category, types of sub-categories, kits, and new arrivals, for example.

Specific products available for purchase, which meet the user-selected element(s) (in other words, the criteria) chosen in row 530 and/or 540 are displayed in the lower half of the display 520 as two rows of elements 560, typically products or services, but here shown as inverters.

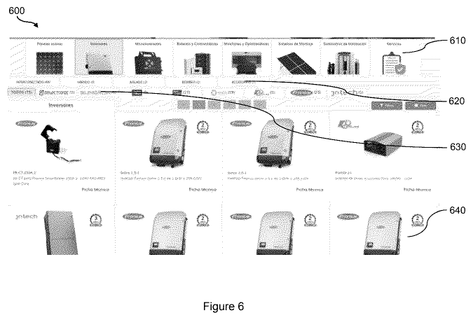

FIG. 6 is an example screenshot 600 of the online hierarchical search for an inverter of a particular brand, where the at least one user 110 of the electronic device 150 selects one class from the presentation of classes (or types or categories) of the products displayed as images or text in row 610 (although illustrated as a row 610 in FIG. 6, the presentation may take the form of a column as well). Further, the at least one user 110 selects a sub-class (sub-type or sub-category) of the product from the choices displayed as series of images or text 620. The at least one user 110 can select a brand from a series of brands 630 available based on the user selections and accordingly view a dynamically changing presentation of product choices 640 that are displayed as a function of the user's selection choices.

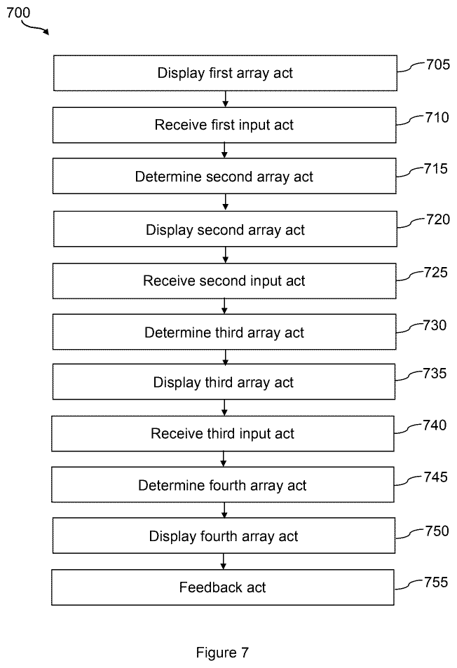

FIG. 7 is an example flow chart 700 illustrating the interactive online shopping algorithm.

In a display first array act 705, the shopping system optimizer 160 displays a first array representing the plurality of first-array tiles on a search window associated with the display screen 152. The first array is presented in the form of the first row (preferably) or the first column on the display screen 152 by tiles having therein words, pictures or brand logos. Each first-array tile includes a first content corresponding to the generalized product meta-category (e.g., solar panel, invertor, mounting equipment for solar panels, washing machine, article of clothing, category of clothing or the like) and/or a generalized service meta-category (e.g., broadcasting service or the like). In a receive first input act 710, the shopping system optimizer 160 receives the first input, a human input, on the first array from the user of the hierarchy-based search system 100. The first input can be, for example, but not limited to a gesture, voice input, touch input, input via input device (e.g., mouse, touchpad, keyboard) or the like.

Next, in a determine second array act 715, the shopping system optimizer 160 determines the second array representing the plurality of second-array tiles based on the context of the first input and common feature associated with the first array. The common feature can be, for example, but not limited an origin of the search (such as nation of origin), a brand, a service availability, a product availability, delivery time, technical assistance availability.

Further, in a display second array act 720, the shopping system optimizer 160 displays the second array represented by tiles by words, pictures or brand, the plurality of second-array tiles on the search window associated with the display screen 152. Each second-array tile includes a second content that narrows the generalized product meta-category to provide the granular product category and the generalized service meta-category to provide the granular service category based on the determination. This is functionally a logical “and” search of the item in the meta category and the item in the granular product category. In an example, when the user has selected the meta category, then the second-row tiles that are displayed relate only to the previously selected first row tile in the display second row or column, and are defined as a granular product category. The granular product category and the generalized service meta-category may be related to a brand.

Next, in a receive second input act 725, the shopping system optimizer 160 receives the second input on the second array from the user of the hierarchy-based search system 100. Further, in a determine third array act 730, the shopping system optimizer 160 determines a third array representing the plurality of third-array tiles based on the context of the second input and the common feature associated with the second array, the tiles having words, pictures or brand logos therein. Further, in a display third array act 735, the shopping system optimizer 160 displays the third array representing the plurality of third-array tiles on the search window associated with the display screen 152. Each third-array tile includes the third content that represents the granular product category into the first sub-type product category and the granular service category into the first sub-type service category. In an example, when the user has selected the third-row tile, then the brands displayed relate only to the previously selected second-row tile. This creates a logical “and” search using each of the selected tile content directed at a database of available products.

Next, in a receive third input act 740, the shopping system optimizer 160 receives a third input on the third array from the user of the hierarchy-based search system 100. In a determine fourth array act 745, the shopping system optimizer 160 determines a fourth array representing the plurality of fourth-array tiles based on the context of the third input and the common feature associated with the third array.

Further, in a display fourth array act 750, the shopping system optimizer 160 displays the fourth array representing the plurality of fourth-array tiles on the search window associated with the display screen 152. The first array, the second array, the third array and the fourth array are arranged in a sequential order so as to continuously “funnel” or in other words limit the number of items that the user will see in the following array. Stated another way, when a product category is selected, the next array will be limited to sub-categories that exist in that product category; when a sub-category is selected, the next array that is displayed will be limited to products or services that exist in that sub-category, etc. (to components, parts, related services, and the like). Each fourth-array tile includes the fourth content that represents the first sub-type product category into the second sub-type product category and the first sub-type service category into the second sub-type service category. In an example, when the user has selected the fourth-row tile, then the brands displayed relate only to the previously selected third-row tile.

In a feedback act 755, the shopping system optimizer 160 receives the feedback from the user of the hierarchy-based search system 100 over a period of time using the machine learning method. Further, the shopping system optimizer 160 indicates the feedback on the first sub-type product category, the first sub-type service category, the second sub-type product category and the second sub-type service category. The feedback represents a rating and a comment, for example, of the product. In an embodiment, the first sub-type product category, the first sub-type service category, the second sub-type product category, and the second sub-type service category are displayed based on a parameter. The parameter may include factors such as cost, popularity, recent launch, time taken for delivery, and service availability, for example.

Based on the outcome of the above acts, the shopping system optimizer 160 performs at least one action. The at least one action corresponds to the end product search, the purchase order, the payment action, the adding to the cart action or combination thereof, for example.

In an example, the online shopping handling block 167 receives a fourth input on the third array from the user of the hierarchy-based search system 100 to perform the action on the first sub-type product category and the first sub-type service category.

In another example, the online shopping handling block 167 receives the fourth input on the fourth array from the user of the hierarchy-based search system 100 to perform the action on the second sub-type product category and the second sub-type service category. The action includes initiating the purchase transaction associated with the first sub-type product category, the first sub-type service category, the second sub-type product category, and the second sub-type service category, for example. Alternatively, the action includes allowing the user of the hierarchy-based search system 100 to add the first sub-type product category, the first sub-type service category, the second sub-type product category, and the second sub-type service category in the cart after selecting the first sub-type product category, the first sub-type service category, the second sub-type product category, and the second sub-type service category based on the demonstrated interests of the user.

Although, the online hierarchical search algorithm 700 is explained in view of the consumer 110, however, the online hierarchical search algorithm 700 is not limited to the consumer 110 only and is also applicable to the other users as explained in conjunction with FIG. 1.

For the adding to the cart action, the shopping system optimizer 160 allows the user of the hierarchy-based search system 100 to add the first sub-type product category, the first sub-type service category, the second sub-type product category, and the second sub-type service category in the cart after selecting the first sub-type product category, the first sub-type service category, the second sub-type product category, and the second sub-type service category based on interest of the user.

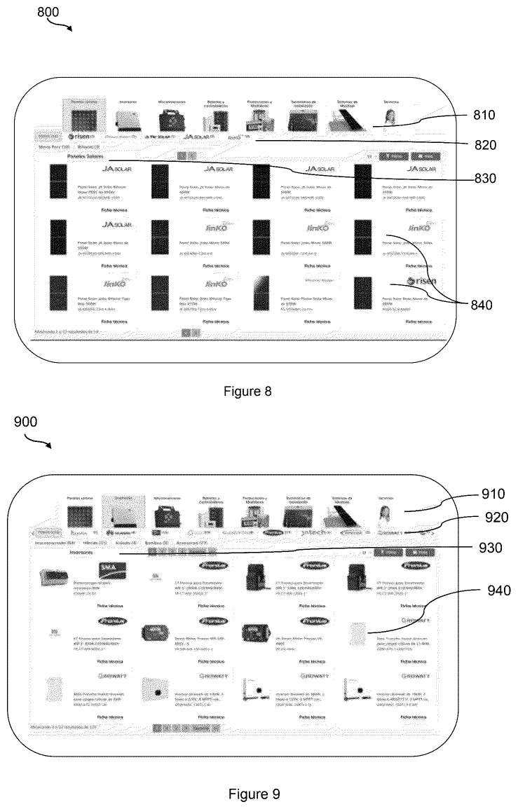

FIG. 8 is an example screenshot 800 of the online hierarchical search for a solar panel. The user 110 of the electronic device 150 selects via human-machine interaction one class from the presentation of classes (or types or categories) of the products displayed as images or text in row 810—here, solar panels. The algorithm 700 then adjust the display of sub-categories to be consistent with solar panels and presents the appropriate array to the user via a GUI or other display device. Next, the user 110 selects the sub-class (sub-type or sub-category) of the product from the choices displayed as series of images or text 820 via a human-machine interaction. For example, the user may select from a brand choice for the product, or as shown here choose to have displayed (and therefore selected) “all brands.” Accordingly, the user 110 can select the brand from a series of brands 820 available based on the user selections and accordingly view a dynamically changing presentation of product choices 830 that are displayed as a function of the user's selection choices for multiple products 840, whereupon the user will select the product they want to purchase or see additional details about.

FIG. 9 is another example screenshot 900 of the online hierarchical search for an invertor (a common solar power product). Here, again, the user 110 of the electronic device 150 selects one class (inventors) from the presentation of classes (or types or categories) of the products displayed as images or text in row 910 via a human-machine interface. Next, the algorithm 700 displays an array of brands associated with inverters to the user.

The user 110 then selects the sub-class (sub-type or sub-category) of the product from the choices displayed as series of images or text in an array 920. Here the user selected to view “all brands” from the array of identified brands. Of course, the user 110 can select only one brand or a plurality of brands from the series of brands available via a human-machine interface. Thereafter, the algorithm 700 displays to the user via a GUI display device alternative an identification of the user-determined category or sub-category (or other limiting constraint), here as a displayed product-type indicator block 930—here, Invertors. Further, products consistent with the displayed product-type indicator block are displayed as a function of the user's selection choices for multiple products 940, here shown as a plurality of invertors.

In short, the display in rows, columns, or in the item display area may display product choices (including brands) shown in an order that “nudges” the customer to pick a particular one, and may be customized by the consumer/customer. In an embodiment, sponsored or featured suggestions such as “best deal” or “most users picked” may be displayed in order to influence purchase behaviour across an array of product and/or category criteria.

Advantageously, the present invention provides a more efficient way of displaying search results, and makes it more convenient and efficient to purchase related products on-line. Additionally, the system 100 and method for storing and comparing shopping cart contents allow a user to compare system-level of purchases such as an entire solar system installation or a branded stereo system by comparing bundled systems based on characteristics such as price, performance, or brand.

Of course, the hierarchical display and selection of products/services or services can belong to any criteria of industry, such as Retail/Grocery/Department stores, Online stores, electrical stores, electric cars, consumer goods (Smart Television, Appliances), solar products, heavy appliances, Fast-moving consumer goods (FMCG), consumer products (clothing, small appliances, books, food, etc.). For example, a user could choose to purchase clothing by first selecting ‘dress wear’, ‘suits’, ‘Ralph Lauren’, and then the specific items or style they desire. Further to the above embodiments, the present invention provides a user the ability to choose more than one criteria of products (by select more than one image or text in a row/column) taking the practical form of a logical OR function across the selected tiles/blocks.

### Caveats

The various actions, acts, blocks, or the like in the flow diagrams may be performed in the order presented, in a different order or simultaneously. Further, in some embodiments, some of the actions, acts, blocks, or the like may be omitted, added, modified, skipped, or the like without departing from the scope of the present invention.

Unless otherwise defined, all technical and scientific terms used herein have the same meaning as commonly understood by one of ordinary skill in the art to which this invention belongs. Although methods and materials similar to or equivalent to those described herein can be used in the practice or testing of equivalent systems and methods, suitable systems and methods and are described above.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

TABLE
List of Reference Numerals/Glossary

| Reference Numeral | Element Name |
|---|---|
| 100 | System (hierarchy-based search system) |
| 110 | Consumer-users |
| 112 | Consumer user interface |
| 120 | Supplier-users |
| 122 | Supplier user interface |
| 130 | Manufacturer-users |
| 132 | Manufacturer user interface |
| 140 | Distributor-users |
| 142 | Distributor user interface |
| 150 | Electronic device (user device) |
| 152 | Display screen |
| 160 | Shopping system optimizer |
| 161 | Processor block |
| 163 | Memory block |
| 165 | Communication block |
| 167 | Online shopping handling block |
| 169 | Artificial Intelligence (AI) block |
| 170 | Local server |
| 500 | Handheld electronic device |
| 510 | Display screen |
| 520 | Display |
| 530 | Product category tool bar row |
| 540 | Row of product or service brands |
| 550 | User feedback display tab |
| 560 | Two rows of elements |
| 600 | Example screenshot |
| 610 | Row |
| 620 | Series of images or text |
| 630 | Series of brands |
| 640 | Product choices |
| 800 | Example screenshot |
| 810 | Series of images or text |
| 820 | Series of brands |
| 830 | Name of the product |
| 840 | Product choices |
| 900 | Example screenshot |
| 910 | Series of images or text |
| 920 | Series of brands |
| 930 | Name of the product |
| 940 | Product choices |

What is claimed is:

1. A hierarchy-based search method, comprising:
displaying, by a hierarchy-based search system, a first array representing a plurality of first-array tiles on a search window associated with a display screen, where each first-array tile comprises a first content corresponding to at least one of: at least one generalized product meta-category and at least one generalized service meta-category;
receiving, by the hierarchy-based search system, a first input on the first array from a user of a hierarchy-based search system;
determining, by the hierarchy-based search system, a second array representing a plurality of second-array tiles based on a context of the first input and a common feature associated with the first array;
displaying, by the hierarchy-based search system, the second array representing the plurality of second-array tiles on the search window associated with the display screen, where each second-array tile comprises a second content that narrows the at least one of: the at least one generalized product meta-category to provide at least one granular product category and the at least one generalized service meta-category to provide at least one granular service category based on the determination;
receiving, by the hierarchy-based search system, a second input on the second array from the user of the hierarchy-based search system;
determining, by the hierarchy-based search system, a third array representing a plurality of third-array tiles based on a context of the second input and a common feature associated with the second array;
displaying, by the hierarchy-based search system, the third array representing the plurality of third-array tiles on the search window associated with the display screen, where each third-array tile comprises a third content that represents at least one of: the at least one granular product category into at least one first sub-type product category and the at least one granular service category into at least one first sub-type service category based on the determination;
receiving, by the hierarchy-based search system, a third input on the third array from the user of the hierarchy-based search system;
determining, by the hierarchy-based search system, a fourth array representing a plurality of fourth-array tiles based on a context of the third input and a common feature associated with the third array; and
displaying, by the hierarchy-based search system, the fourth array representing the plurality of fourth-array tiles on the search window associated with the display screen, where each fourth-array tile comprises a fourth content that represents at least one of: the at least one first sub-type product category into at least one second sub-type product category and the at least one first sub-type service category into at least one second sub-type service category.

2. The hierarchy-based search method of claim 1 further comprising:
performing, by the hierarchy-based search system, at least one of:
receiving a fourth input on the third array from the user of the hierarchy-based search system to perform at least one action on at least one of: the at least one first sub-type product category and the at least one first sub-type service category, and
receiving a fourth input on the fourth array from the user of the hierarchy-based search system to perform at least one action on at least one of: the at least one second sub-type product category and the at least one second sub-type service category.

3. The hierarchy-based search method of claim 2 wherein the at least one action comprises initiating a purchase transaction associated with at least one of: the at least one first sub-type product category, the at least one first sub-type service category, the at least one second sub-type product category, and the at least one second sub-type service category.

4. The hierarchy-based search method of claim 2 wherein the at least one action comprises allowing the user of the hierarchy-based search system to add at least one of: the at least one first sub-type product category, the at least one first sub-type service category, the at least one second sub-type product category, and the at least one second sub-type service category in a cart after selecting at least one of: the at least one first sub-type product category, the at least one first sub-type service category, the at least one second sub-type product category, and the at least one second sub-type service category based on interest of the user.

5. The hierarchy-based search method of claim 1 further comprising:
receiving, by the hierarchy-based search system, a feedback from the user of the hierarchy-based search system over a period of time using a machine learning method; and
indicating, by the hierarchy-based search system, the feedback on at least one of: the at least one first sub-type product category, the at least one first sub-type service category, the at least one second sub-type product category and the at least one second sub-type service category, wherein the feedback represents at least one of a rating and a comment.

6. The hierarchy-based search method of claim 1 wherein at least one of: the at least one first sub-type product category, the at least one first sub-type service category, the at least one second sub-type product category, and the at least one second sub-type service category are displayed based on at least one parameter, wherein the at least one parameter comprises cost, popularity, recent launch, time taken for delivery, and service availability.

7. The hierarchy-based search method of claim 1 wherein the first array, the second array, the third array and the fourth array are arranged in a sequential order.

8. A hierarchy-based search system, comprising:
a processor;
a memory; and
an online shopping handling block, coupled with the processor and the memory, configured to:
display a first array representing a plurality of first-array tiles on a search window associated with a display screen, where each first-array tile comprises a first content corresponding to at least one of: at least one generalized product meta-category and at least one generalized service meta-category;
receive a first input on the first array from a user of a hierarchy-based search system;
determine a second array representing a plurality of second-array tiles based on a context of the first input and a common feature associated with the first array;
display the second array representing the plurality of second-array tiles on the search window associated with the display screen, where each second-array tile comprises a second content that narrows the at least one of: the at least one generalized product meta-category to provide at least one granular product category and the at least one generalized service meta-category to provide at least one granular service category based on the determination;
receive a second input on the second array from the user of the hierarchy-based search system;
determine a third array representing a plurality of third-array tiles based on a context of the second input and a common feature associated with the second array;
display the third array representing the plurality of third-array tiles on the search window associated with the display screen, where each third-array tile comprises a third content that represents at least one of: the at least one granular product category into at least one first sub-type product category and the at least one granular service category into at least one first sub-type service category based on the determination;
receive a third input on the third array from the user of the hierarchy-based search system;
determine a fourth array representing a plurality of fourth-array tiles based on a context of the third input and a common feature associated with the third array; and
display the fourth array representing the plurality of fourth-array tiles on the search window associated with the display screen, where each fourth-array tile comprises a fourth content that represents at least one of: the at least one first sub-type product category into at least one second sub-type product category and the at least one first sub-type service category into at least one second sub-type service category.

9. The hierarchy-based search system of claim 8 wherein the online shopping handling block is configured to:
perform at least one of:
receive a fourth input on the third array from the user of the hierarchy-based search system to perform at least one action on at least one of: the at least one first sub-type product category and the at least one first sub-type service category, and
receive a fourth input on the fourth array from the user of the hierarchy-based search system to perform at least one action on at least one of: the at least one second sub-type product category and the at least one second sub-type service category.

10. The hierarchy-based search system of claim 9 wherein the at least one action comprises initiating a purchase transaction associated with at least one of: the at least one first sub-type product category, the at least one first sub-type service category, the at least one second sub-type product category, and the at least one second sub-type service category.

11. The hierarchy-based search system of claim 9 wherein the at least one action comprises allowing the user of the hierarchy-based search system to add at least one of: the at least one first sub-type product category, the at least one first sub-type service category, the at least one second sub-type product category, and the at least one second sub-type service category in a cart after selecting at least one of: the at least one first sub-type product category, the at least one first sub-type service category, the at least one second sub-type product category, and the at least one second sub-type service category based on interest of the user.

12. The hierarchy-based search system of claim 8 wherein the online shopping handling block is configured to:
receive a feedback from the user of the hierarchy-based search system over a period of time using a machine learning method; and
indicate the feedback on at least one of: the at least one first sub-type product category, the at least one first sub-type service category, the at least one second sub-type product category and the at least one second sub-type service category, wherein the feedback represents at least one of a rating and a comment.

13. The hierarchy-based search system of claim 8 wherein at least one of: the at least one first sub-type product category, the at least one first sub-type service category, the at least one second sub-type product category, and the at least one second sub-type service category are displayed based on at least one parameter, wherein the at least one parameter comprises cost, popularity, recent launch, time taken for delivery, and service availability.

14. The hierarchy-based search system of claim 8 wherein the first array, the second array, the third array and the fourth array are arranged in a sequential order.

15. A computer program product comprising a non-transitory computer readable medium, having thereon machine-readable instructions which, when loaded and executed by one or more processors or processing circuitry, are configured to cause the method of claim 1 to be performed.
